(19) United States
(12) Patent Application Publication
(10) Pub. No.: US 2004/0172438 A1
(43) Pub. Date: Sep. 2, 2004

(54) Method for compensating for a phase error in a reception and/or transmission system having an I/Q interface

(76) Inventor: Bertram Gunzelmann, Konigsbrunn (DE)

Correspondence Address: Andreas Grubert, Baker Botts L.L.P., One Shell Plaza, 910 Louisiana, Houston, TX, 77002-4995, US

(21) Appl. No.: 10/758,795

(22) Filed: Jan. 16, 2004

Related U.S. Application Data
(63) Continuation of application No. PCT/DE02/02356, filed on Jun. 27, 2002.

(30) Foreign Application Priority Data
Jul. 25, 2001 (DE) 101 36 071.1

(51) Int. Cl. G06F 7/52

(52) U.S. Cl. 708/607

(57) ABSTRACT

In a method for compensating for a phase error in a reception and/or transmission system having I and Q processing paths, phase corrected I and Q signal components are computed in a computation stage (PC) in a digital signal processing section (10′) of the I and Q signal processing paths.

### CROSS REFERENCE TO RELATED APPLICATION

This application is a continuation of copending International Application No. PCT/DE02/02356 filed Jun. 27, 2002 which designates the United States, and claims priority to German application no. 101 36 071.1 filed Jul. 25, 2001.

### TECHNICAL FIELD OF THE INVENTION

The present invention relates to a method and apparatus for compensating for a phase error in a reception and/or transmission system having I and Q signal processing paths.

### DESCRIPTION OF THE RELATED ART

In data transmission systems generally and particularly in the area of mobile radio, ever higher data rates are sought after. Whereas second generation mobile radio systems were still limited by data rates in the region of 10 kbit/s, third generation mobile radio systems, for example UMTS (Universal Mobile Telecommunications System), are able to achieve data rates in the region of 2 Mbit/s.

One possibility for attaining higher data rates involves changing over to higher level modulation methods. An example of this is the further development of the GSM (Global System for Mobile Communications) standard into the EDGE (Enhanced Data Services for GSM Evolution) standard and the associated transition from the 2-level GMSK (Gaussian Minimum Shift Keying) modulation method to the 8-level 8 PSK (Phase Shift Keying) modulation method.

The transition to higher level modulation methods increases the demands on phase accuracy for the signal processing in the inphase (I) and quadrature (Q) paths of a reception and transmission system. The I and Q signal paths ideally have a phase shift of exactly 90° with respect to one another.

A chipset for a transmission and/or reception system in the GSM/UMTS standard normally comprises a baseband chip, which is responsible for the baseband signal processing and the analog-to-digital and digital-to-analog conversion, and a radio frequency chip, which converts received signals from a carrier frequency to the baseband and converts signals which are to be transmitted from the baseband to the carrier frequency. The frequency conversion is used to generate (in the case of a reception system) or to combine (in the case of a transmission system) the I and Q signal components. In this case, the difficulty may arise that manufacturing or environment-related component tolerances mean that the prescribed angular difference of 90° between the I and Q paths is not maintained exactly upon this conversion.

A phase error in the reception system causes a fault in the received signal, which worsens the bit error rate for a prescribed signal-to-noise ratio of the received signal. In the transmission system, a phase error causes distortion of the signal shape, which results in a reduction in the special purity of the transmitted signal.

If a higher level modulation alphabet is used, the disadvantageous repercussions of said effects are increased in both cases, because the demands on the angular accuracy of the signal detection or signal generation increase.

The invention is therefore based on the object of specifying a method which allows a phase difference of 90° to be maintained with good accuracy in a reception and/or transmission system having I and Q signal processing paths. The invention also aims to provide a reception and transmission system having I and Q signal processing paths which satisfies this condition with a good level of accuracy.

### SUMMARY OF THE INVENTION

The object on which the invention is based can be achieved by a method for compensating for a phase error in a transmission system having I and Q signal processing paths, comprising the following steps:

programming a phase error Δφ, previously ascertained by measurement, in a radio frequency transmission stage used in the transmission system into the digital signal processing section of the transmission system when the transmission system is first fitted or when it is maintained; and

computing phase corrected I and Q signal components in a digital signal processing section of the I and Q signal processing paths during transmission mode by correcting I and Q signal components with the programmed constant phase error Δφ.

The object can also be achieved by a method for compensating for a phase error in a reception system having I and Q signal processing paths, comprising the following steps:

programming a phase error Ad, previously ascertained by measurement, in a radio frequency reception stage used in the reception system into the digital signal processing section of the reception system when the reception system is first fitted or when it is maintained; and

computing phase corrected I and Q signal components in a digital signal processing section of the I and Q signal processing paths of the reception system during reception mode by correcting I and Q signal components containing phase errors with the programmed constant phase error Δφ.

The object can furthermore be achieved by a reception and/or transmission system having I and Q signal processing paths, comprising a computation unit which is provided in a digital signal processing section of the I and Q signal processing paths and performs phase correction for the I and Q signal components, wherein the computation unit is operable to program a phase error Δφ, previously ascertained by measurement, in a radio frequency transmission stage used in the transmission system into the digital signal processing section of the transmission system when the transmission system is first fitted or when it is maintained; and the computation unit is further operable to compute phase corrected I and Q signal components in a digital signal processing section of the I and Q signal processing paths during transmission mode by correcting I and Q signal components with the programmed constant phase error Δφ.

The object can also be achieved by a reception and/or transmission system having I and Q signal processing paths, comprising a computation unit which is provided in a digital signal processing section of the I and Q signal processing paths and performs phase correction for the I and Q signal components, wherein the computation unit is operable to program a phase error Δφ, previously ascertained by measurement, in a radio frequency reception stage used in the reception system into the digital signal processing section of the reception system when the reception system is first fitted or when it is maintained; and the computation unit is further operable to compute phase corrected I and Q signal components in a digital signal processing section of the I and Q signal processing paths of the reception system during reception mode by correcting I and Q signal components containing phase errors with the programmed constant phase error Δφ.

In line with the invention, phase corrected I and Q signal components are computed in a digital signal processing section of the I and Q signal processing paths. The phase correction in the digital signal processing section allows the phase angle of the I and Q signal components to be set to the desired phase difference of 90° in a manner which is accurate and independent of environmental influences or drifts.

Preferably, the phase corrected I and Q signal components are computed on the basis of

$$[ \begin{matrix}I ( Δφ ) \\ Q ( Δφ )\end{matrix} ] = [ \begin{matrix}cos ( Δφ / 2 ) & - sin ( Δφ / 2 ) \\ - sin ( Δφ / 2 ) & cos ( Δφ / 2 )\end{matrix} ] [ \begin{matrix}I \\ Q\end{matrix} ]$$

or on the basis of an approximation of this equation, where I and Q are the I and Q signal components containing phase errors, I(Δφ) and Q(Δφ) are the phase error compensated I and Q signal components, and Δφ is the phase error used for the correction.

On account of the rotation matrix indicated in this equation, a phase difference of 90°+Δφ is transformed by computer into the desired phase difference of 90°.

Since it is generally necessary to take into account phase errors of Δφ<10° only, a method variant which is more favorable to implementation is achieved by the approximative computation cited in claim 3. The advantage is that there is no computation of the angle functions cos(.) and sin (.).

The phase error Δφ used for the correction can be ascertained in various ways. In accordance with a first advantageous refinement of the inventive method, the ascertainment of the phase error Δφ can be based on a statistical method, based on measurements of the phase errors in a multiplicity of radio frequency stages. By way of example, the phase error Δφ is ascertained as the mean of all measured phase errors in a particular set (e.g. quantity delivered or batch) of radio frequency stages for constructing reception and/or transmission systems with the invention's correction opportunity. The phase error Δφ determined in this manner is then programmed into the corresponding computation means for performing phase correction. This procedure is advantageous if, during manufacture or fitting of the radio frequency stages, a systematic mean deviation from the desired 90° phase difference between the I and Q signal processing paths appears and the standard deviation of the corresponding distribution is comparatively small.

Another, likewise preferred refinement of the inventive method is characterized by a value for the phase error Δφ used for the correction being ascertained by measuring the phase error in a particular radio frequency stage, and the phase error Δφ ascertained in this manner being programmed into the reception and/or transmission system equipped with this particular radio frequency stage. In this way, a targeted and individual single correction of the phase error is made in each transmission and/or reception system.

A reception and/or transmission system based on the invention is preferably contained in a mobile radio receiver.

### BRIEF DESCRIPTION OF THE DRAWINGS

The invention is explained in more detail below using exemplary embodiments with reference to the drawing, in which:

FIG. 1 shows a block diagram of a transmission device in a mobile station based on the prior art;

FIG. 2 shows a block diagram of a reception device in a mobile station based on the prior art;

FIG. 3 shows an illustration of an equivalent baseband signal in the complex plane for a phase error Δφ=0°

FIG. 4 shows an illustration of the equivalent baseband signal in the complex plane for a phase error Δφ=5°;

FIG. 5 shows a block diagram of a transmission device with digital phase correction, based on the invention;

FIG. 6 shows a block diagram of a reception device with digital phase correction based on the invention; and

FIG. 7 shows the baseband signal for a phase error Δφ=5° following the phase correction based on the invention.

### DETAILED DESCRIPTION OF THE PREFERRED EMBODIMENTS

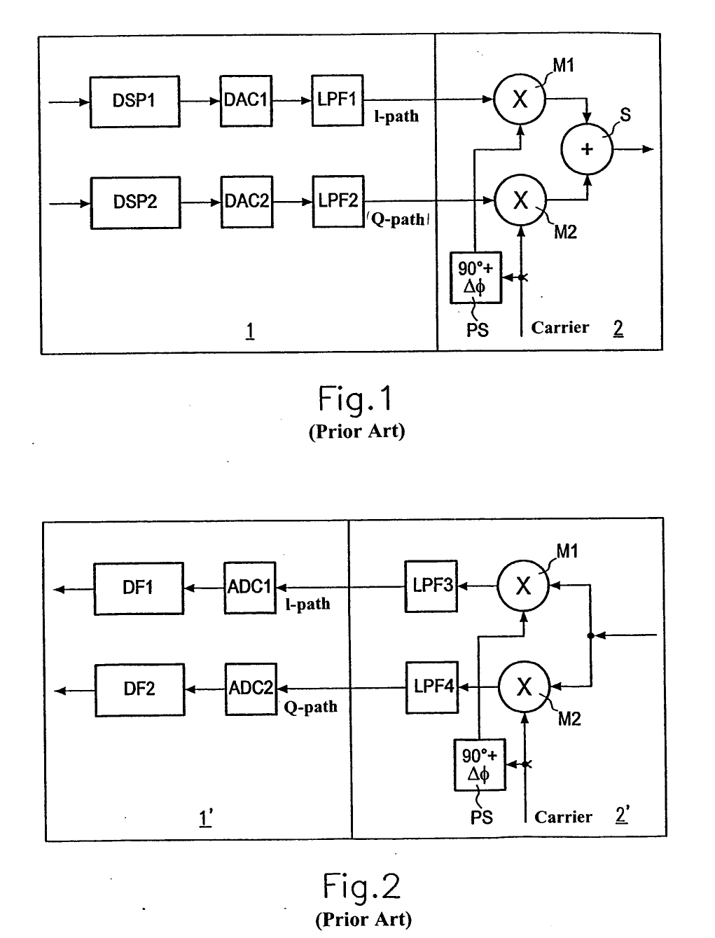

FIG. 1 shows the signal processing path in a conventional transmission device used in mobile telephones, for example. From the point of view of implementation, the transmission signal path is made up of a first section 1, which is in the form of a baseband chip, and a second section 2 which is in the form of a radio frequency chip.

An already modulated data signal attributed to a data source (e.g. speech) is subjected to signal preprocessing (rate conversion and interpolation steps are customary) separately for the I and Q paths using two digital signal processors DSP1 and DSP2. The modulated signal's I and Q signal components produced in this manner are respectively converted into analog baseband signals in digital-to-analog converters DAC1 and DAC2. The signal conversion is followed by low pass filtering using the low pass filters LPF1 and LPF2. The modulated analog and low pass filtered I and Q signal components are input into the radio frequency signal processing section 2 via the “I/Q interface” for carrier signal conversion. The carrier signal conversion takes place there by up-converting the analog I and Q signal components in mixers M1 and M2 using two carriers, ideally phase shifted through 90°. The modulated carrier signals produced in the mixers M1 and M2 are superimposed on one another in a summation stage S and are radiated as a radio frequency signal via an antenna (not shown).

The conventional reception device shown in FIG. 2 essentially performs inverse signal processing. From the point of view of implementation, the reception device can be produced in the same two chips (RF chip and baseband chip) as the transmission device, and FIG. 2 shows the corresponding signal processing sections 1′ and 2′ of the reception path within the respective chips.

The same or comparable parts as in FIG. 1 are denoted by the same reference symbols in FIG. 2. The modulated carrier signal received via an antenna (not shown) is down-converted to the baseband or to an intermediate frequency using the mixers M1 and M2. For this purpose, the mixers M1, M2 are in turn operated by two orthogonal carriers which are generated from a single carrier using a phase shifter PS. The phase shift brought about by the phase shifter PS is ideally 90° in this case too.

The I and Q signal components produced by the mixers M1 and M2 are respectively subjected to low pass filtering in analog low pass filters LPF3, LPF4 and are then supplied to the signal processing section 1′ in the baseband chip via the I/Q interface (indicated by the dividing line shown in FIG. 2 between the sections 1′ and 2′). At this point the I signal component is converted, using an analog-to-digital converter ADC1 and the Q signal component is converted, using an analog-to-digital converter ADC2, into digital signals. Further channel filtering is ensured by two separate digital filters DF1 and DF2.

If the phase difference between the two carriers associated with the mixing stages M1, M2 differs from the desired 90° phase difference by a sum Δφ, then a resultant phase difference of 90° +Δφ is obtained when up-converting and down-converting the transmitted and received signals. In this case, Δφ is referred to as the phase error. The phase error Δφ can be brought about by the phase shifter PS or else by other signal processing elements (not shown) or influencing variables in the transmission and reception devices shown.

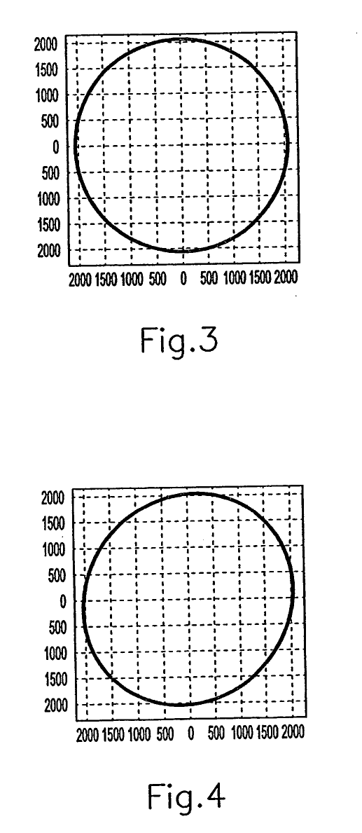

FIG. 3 plots, for a pure sinusoidal carrier signal, the I signal component over the Q signal component for the case Δφ=0°. Arbitrary units are used. Without a phase error, the sinusoidal carrier signal is depicted exactly on a complex sine (circle of unit radius), see FIG. 3.

FIG. 4 shows an illustration corresponding to that in FIG. 3 for a phase error Δφ=5°. On account of the carrier signals no longer being orthogonal, reciprocal noise components are received for the I and Q signal components, these noise components resulting in deformation of the signal, which becomes apparent as a deviation from the circle shape.

As already mentioned, such a signal fault has a deleterious effect on the overall transmission response both in the transmission direction and in the reception direction. A phase error Δφ in the reception direction causes a fault in the received signal, which results in an increase in the bit error rate (for a fixed signal-to-noise ratio). In the transmission device, the purity of the transmitted signal is impaired by the distortion shown.

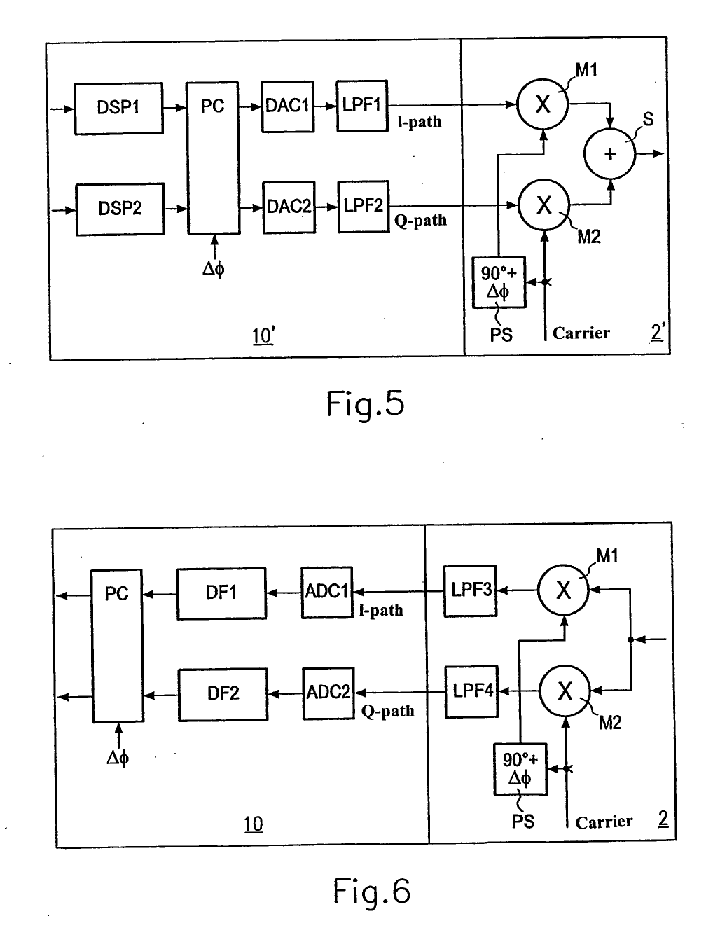

FIGS. 5 and 6 show transmission and reception devices in which the invention involves the phase error being corrected in the digital processing area. To avoid repetition in the description of the invention's exemplary embodiments, reference is made to the description relating to FIGS. 1 and 2, which remains valid for the invention's exemplary embodiments. The fundamental difference between the transmission devices shown in FIGS. 1 and 5 is that a phase correction stage PC is provided in the signal paths between the digital signal processors DSP1, DSP2 and the digital-to-analog converts DAC1, DAC2. The corresponding signal processing section in the baseband chip is denoted by the reference symbol 10′. In a similar manner, the fundamental difference between the reception devices shown in FIG. 2 and in FIG. 6 is that a phase correction stage PC preferably follows in the signal path downstream of the digital filters DF1, DF2, with the changed signal processing section in the baseband being denoted by the reference symbol 10 in this case.

The phase correction stages PC used in the signal processing sections 10 and 10′ can be of the same design. Their mode of action is explained below:

A phase error existing in the equivalent baseband can be modeled by the following matrix operation:

$$[ \begin{matrix}I \\ Q\end{matrix} ] = [ \begin{matrix}cos ( Δφ / 2 ) & sin ( Δφ / 2 ) \\ sin ( Δφ / 2 ) & cos ( Δφ / 2 )\end{matrix} ] [ \begin{matrix}{I}_{0} \\ {Q}_{0}\end{matrix} ]$$

In this case, I₀ and Q₀ denote carrier signals with the optimum phase difference of 90°, and I and Q denote the I and Q signal components containing phase errors.

This phase error Δφ is now ideally fully reversed again in a reception path and/or in the transmission path by the following matrix operation:

$$[ \begin{matrix}I ( Δφ ) \\ Q ( Δφ )\end{matrix} ] = [ \begin{matrix}cos ( Δφ / 2 ) & - sin ( Δφ / 2 ) \\ - sin ( Δφ / 2 ) & cos ( Δφ / 2 )\end{matrix} ] [ \begin{matrix}I \\ Q\end{matrix} ]$$

This computation code is executed by the phase correction stage PC. A (theoretically) exact correction of the phase error is not required in most cases, however. Application of an approximated derotation matrix on the basis of the equation

$$[ \begin{matrix}I ( Δφ ) \\ Q ( Δφ )\end{matrix} ] = [ \begin{matrix}1 - Δφ / 2 & - Δφ / 2 \\ - Δφ / 2 & 1 - Δφ / 2\end{matrix} ] [ \begin{matrix}I \\ Q\end{matrix} ]$$

produces a digital phase correction with much less computation complexity. This applies both to the phase correction stage PC in the transmission device and to the phase correction stage PC in the reception device.

The phase error Δφ to be applied in the phase correction stage PC can be determined in various ways. A first option is for the phase error Δφ which is to be corrected to be determined once and programmed into the phase correction stage PC when the appliance is first fitted. The appliance then has phase error compensation for the rest of its operation. In this case, determination of the phase error Ad can be ascertained on an appliance basis by measuring the phase error Δφ which actually occurs in the respective appliance or else statistically by measuring the phase errors for a multiplicity of appliances of the same design or series.

In addition, it is also possible to readjust the phase error Δφ when checking or maintaining the appliance, and it is likewise conceivable for the phase error Δφ to be repeatedly determined and updated during operation of the appliance using a measuring device integrated into the appliance.

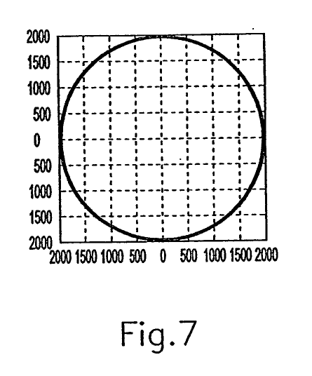

FIG. 7 shows an illustration, comparable to FIGS. 3 and 4, of the phase relationship between the I and Q signal components of the baseband signal following the performance of phase error compensation in accordance with the invention. The illustration is based on a baseband signal having a phase error of Δφ=5°, as shown in FIG. 4 without the use of the invention's phase error compensation stage PC. It is not possible to see a difference from the ideal complex sine signal with a phase difference of exactly 90°, cf. FIG. 3.

I claim:

1. A method for compensating for a phase error in a transmission system having I and Q signal processing paths, comprising the following steps:
programming a phase error Δφ, previously ascertained by measurement, in a radio frequency transmission stage used in the transmission system into the digital signal processing section of the transmission system when the transmission system is first fitted or when it is maintained; and
computing phase corrected I and Q signal components in a digital signal processing section of the I and Q signal processing paths during transmission mode by correcting I and Q signal components with the programmed constant phase error Δφ.

2. The method as claimed in claim 1, wherein the computation is performed on the basis of
$$[ \begin{matrix}I ( Δφ ) \\ Q ( Δφ )\end{matrix} ] = [ \begin{matrix}cos ( Δφ / 2 ) & - sin ( Δφ / 2 ) \\ - sin ( Δφ / 2 ) & cos ( Δφ / 2 )\end{matrix} ] [ \begin{matrix}I \\ Q\end{matrix} ]$$
or on the basis of an approximation of this equation, where I and Q are the I and Q signal components containing phase errors, I(Δφ) and Q(Δφ) are the phase error compensated I and Q signal components, and Δφ is the phase error used for the correction.

3. The method as claimed in claim 2, wherein the computation is performed on the basis of
$$[ \begin{matrix}I ( Δφ ) \\ Q ( Δφ )\end{matrix} ] = [ \begin{matrix}1 - Δφ / 2 & - Δφ / 2 \\ - Δφ / 2 & 1 - Δφ / 2\end{matrix} ] [ \begin{matrix}I \\ Q\end{matrix} ]$$

4. The method as claimed in claim 1, comprising the following step: ascertaining a value for the phase error Δφ used for the correction using a statistical method based on measurements of the phase errors in a multiplicity of radio frequency transmission stages and radio frequency reception stages.

5. The method as claimed in claim 1, comprising the following step: ascertaining a value for the phase error Δφ used for the correction by measuring the phase error in a particular radio frequency transmission stage or radio frequency reception stage.

6. A method for compensating for a phase error in a reception system having I and Q signal processing paths, comprising the following steps:
programming a phase error Δφ, previously ascertained by measurement, in a radio frequency reception stage used in the reception system into the digital signal processing section of the reception system when the reception system is first fitted or when it is maintained; and
computing phase corrected I and Q signal components in a digital signal processing section of the I and Q signal processing paths of the reception system during reception mode by correcting I and Q signal components containing phase errors with the programmed constant phase error Δφ.

7. The method as claimed in claim 6, wherein the computation is performed on the basis of
$$[ \begin{matrix}I ( Δφ ) \\ Q ( Δφ )\end{matrix} ] = [ \begin{matrix}cos ( Δφ / 2 ) & - sin ( Δφ / 2 ) \\ - sin ( Δφ / 2 ) & cos ( Δφ / 2 )\end{matrix} ] [ \begin{matrix}I \\ Q\end{matrix} ]$$
or on the basis of an approximation of this equation, where I and Q are the I and Q signal components containing phase errors, I(Δφ) and Q(Δφ) are the phase error compensated I and Q signal components, and Δφ is the phase error used for the correction.

8. The method as claimed in claim 7, wherein the computation is performed on the basis of
$$[ \begin{matrix}I ( Δφ ) \\ Q ( Δφ )\end{matrix} ] = [ \begin{matrix}1 - Δφ / 2 & - Δφ / 2 \\ - Δφ / 2 & 1 - Δφ / 2\end{matrix} ] [ \begin{matrix}I \\ Q\end{matrix} ]$$

9. The method as claimed in claim 6, comprising the following step:
ascertaining a value for the phase error Δφ used for the correction using a statistical method based on measurements of the phase errors in a multiplicity of radio frequency transmission stages and radio frequency reception stages.

10. The method as claimed in claim 6, comprising the following step:
ascertaining a value for the phase error Δφ used for the correction by measuring the phase error in a particular radio frequency transmission stage or radio frequency reception stage.

11. A reception and/or transmission system having I and Q signal processing paths, comprising a computation unit which is provided in a digital signal processing section of the I and Q signal processing paths and performs phase correction for the I and Q signal components, wherein the computation unit is operable to program a phase error Δφ, previously ascertained by measurement, in a radio frequency transmission stage used in the transmission system into the digital signal processing section of the transmission system when the transmission system is first fitted or when it is maintained; and the computation unit is further operable to compute phase corrected I and Q signal components in a digital signal processing section of the I and Q signal processing paths during transmission mode by correcting I and Q signal components with the programmed constant phase error Δφ.

12. The reception and/or transmission system as claimed in claim 11, wherein the computation unit is designed to perform the computation on the basis of
$$[ \begin{matrix}I ( Δφ ) \\ Q ( Δφ )\end{matrix} ] = [ \begin{matrix}cos ( Δφ / 2 ) & - sin ( Δφ / 2 ) \\ - sin ( Δφ / 2 ) & cos ( Δφ / 2 )\end{matrix} ] [ \begin{matrix}I \\ Q\end{matrix} ]$$
or on the basis of an approximation of this equation, where I and Q are the I and Q signal components containing phase errors, I(Δφ) and Q(Δφ) are the phase error compensated I and Q signal components, and Δφ is the phase error used for the correction.

13. The reception and/or transmission system as claimed in claim 12, wherein the computation unit is designed to perform the computation on the basis of
$$[ \begin{matrix}I ( Δφ ) \\ Q ( Δφ )\end{matrix} ] = [ \begin{matrix}1 - Δφ / 2 & - Δφ / 2 \\ - Δφ / 2 & 1 - Δφ / 2\end{matrix} ] [ \begin{matrix}I \\ Q\end{matrix} ]$$

14. The reception and/or transmission system as claimed in claim 11, wherein the computation unit is designed to perform the computation on the basis of the CORDIC algorithm.

15. A reception and/or transmission system having I and Q signal processing paths, comprising a computation unit which is provided in a digital signal processing section of the I and Q signal processing paths and performs phase correction for the I and Q signal components, wherein the computation unit is operable to program a phase error Δφ, previously ascertained by measurement, in a radio frequency reception stage used in the reception system into the digital signal processing section of the reception system when the reception system is first fitted or when it is maintained; and the computation unit is further operable to compute phase corrected I and Q signal components in a digital signal processing section of the I and Q signal processing paths of the reception system during reception mode by correcting I and Q signal components containing phase errors with the programmed constant phase error Δφ.

16. The reception and/or transmission system as claimed in claim 15, wherein the computation unit is designed to perform the computation on the basis of
$$[ \begin{matrix}I ( Δφ ) \\ Q ( Δφ )\end{matrix} ] = [ \begin{matrix}cos ( Δφ / 2 ) & - sin ( Δφ / 2 ) \\ - sin ( Δφ / 2 ) & cos ( Δφ / 2 )\end{matrix} ] [ \begin{matrix}I \\ Q\end{matrix} ]$$
or on the basis of an approximation of this equation, where I and Q are the I and Q signal components containing phase errors, I(Δφ) and Q(Δφ) are the phase error compensated I and Q signal components, and Δφ is the phase error used for the correction.

17. The reception and/or transmission system as claimed in claim 16, wherein the computation unit is designed to perform the computation on the basis of
$$[ \begin{matrix}I ( Δ φ ) \\ Q ( Δφ )\end{matrix} ] = [ \begin{matrix}1 - Δφ / 2 & - Δφ / 2 \\ - Δφ / 2 & 1 - Δφ / 2\end{matrix} ] [ \begin{matrix}I \\ Q\end{matrix} ]$$

18. The reception and/or transmission system as claimed in claim 15, wherein the computation unit is designed to perform the computation on the basis of the CORDIC algorithm.
